(19) United States
(12) Patent Application Publication
(10) Pub. No.: US 2020/0335745 A1
(43) Pub. Date: Oct. 22, 2020

(54) BATTERY MODULE AND BATTERY PACK

(71) Applicant: CONTEMPORARY AMPEREX TECHNOLOGY CO., LIMITED, Ningde City (CN)

(72) Inventors: Yujia HOU, Ningde City (CN); Shubing YOU, Ningde City (CN); Jihua YAO, Ningde City (CN)

(21) Appl. No.: 16/552,261

(22) Filed: Aug. 27, 2019

(30) Foreign Application Priority Data
Apr. 18, 2019 (CN) 201920528556.6

(51) Int. Cl. H01M 2/10

(52) U.S. Cl. CPC H01M 2/1077; H01M 2220/20

(57) ABSTRACT

The present disclosure provides a battery module and a battery pack. The battery module includes: a battery unit array structure including a plurality of battery units stacked along a length direction and having two opposite end portions along the length direction and two opposite side portions along a width direction; and at least two connecting components spaced apart from each other, each of them having a first holding portion and a second holding portion. In each connecting component, the first holding portion is located at one end portion and connected to a part of the end portions, and the second holding portion is located at one side portion and connected to a part of the side portion. The holding portions have the smaller volume and weight, which can improve the energy density and space utilization of the battery module and the battery pack.

### CROSS-REFERENCE TO RELATED APPLICATIONS

The present application claims priority to Chinese Patent Application No. 201920528556.6, filed on April 18, 2019, the content of which is incorporated herein by reference in its entirety.

### TECHNICAL FIELD

The present disclosure relates to the technical field of energy storage, and in particular, to a battery module and a battery pack.

### BACKGROUND

The power battery of the vehicle includes a case and a plurality of battery modules located in the case. Each battery module includes a plurality of batteries stacked on each other. Two end plates are provided at two ends of the plurality of batteries along the length direction, and two side plates are provided on two sides of the plurality of batteries along the width direction. The end plates are fixedly connected to the side plates to fix the batteries and form a battery module. In the battery module, in addition to the batteries, the end plates and the side plates occupy a relatively large space and have a relatively great weight, thereby resulting in low space utilization and a low energy density of the battery module and the power battery.

### SUMMARY

In view of the above, the present disclosure provides a battery module and a battery pack, aiming to solve the problems in the related art, i.e., the low space utilization and energy density of the battery module and the battery pack, which is caused by the large volume and great weight of the end plates and the side plates of the battery module known in the related art.

The present disclosure provides a battery module. The battery module includes: a battery unit array structure, which includes a plurality of battery units stacked along a length direction and has two opposite end portions along the length direction and two opposite side portions along a width direction; and at least two connecting components spaced apart from each other, each of the at least two connecting components including a first holding portion and a second holding portion. In each of the at least two connecting components , the first holding portion is located at one of the two end portions of the battery unit array structure along the length direction, and connected to a part of the one of the two end portions. In each of the at least two connecting components, the second holding portion is located at one of the two side portions of the battery unit array structure along the width direction, and connected to a part of the one of the two side portions.

In an embodiment, each of the at least two connecting components includes a first holding plate and a second holding plate perpendicular to the first holding plate. The first holding plate is the first holding portion, and the second holding plate is the second holding portion. The first holding plate has a smaller area than the end portions, and the second holding plate has a smaller area than the side portions.

In an embodiment, the battery module further includes at least one bundling belt surrounding the battery unit array structure and the at least two connecting components. Each of the at least two connecting components is provided with a groove, and along a height direction, a part of the at least one bundling belt is disposed in the groove.

In an embodiment, the battery module further includes at least two insulating components, wherein each of the at least two insulating components is disposed between one of the least two connecting components and the battery unit array structure.

In an embodiment, each of the at least two insulating components includes a first insulating plate and a second insulating plate. The first insulating plate covers at least the first holding plate, and the second insulating plate covers at least the second holding plate.

In an embodiment, each of the at least two insulating components further includes a third insulating plate and a fourth insulating plate. The third insulating plate is connected to a top of the first insulating plate and a top of the second insulating plate, and the third insulating plate abuts against a top of the battery unit array structure. The fourth insulating plate is connected to a bottom of the first insulating plate and a bottom of the second insulating plate, and the fourth insulating plate abuts against a bottom of the battery unit array structure.

In an embodiment, each of the least two connecting components further includes a first connecting portion, and the first connecting portion is configured to be connected to an adjacent battery module.

The present disclosure further provides a battery pack, including a case having an inner cavity, and a plurality of battery modules disposed in the inner cavity. Each of the plurality of battery modules is the battery module described above.

In an embodiment, each of the least two connecting components includes a first connecting portion, and the first connecting portion includes a first connecting plate and/or a second connecting plate. Along the length direction, two adjacent battery modules of the plurality of battery modules are fixedly connected by the first connecting plate; and/ or along the width direction, two adjacent battery modules of the plurality of battery modules are fixedly connected by the second connecting plate.

Each of the least two connecting components includes a second connecting portion. The second connecting portion is fixed to a bottom of the first holding portion and a bottom of the second holding portion, and/or the second connecting portion is fixed to a top of the first holding portion and a second holding portion.

In the present disclosure, along the length direction, two ends of the battery unit array structure are fixedly connected by at least two first holding portions, and along the width direction, two sides of the battery unit array structure are fixedly connected by at least two second holding portions, such that the battery units are integrally connected in the length direction and the width direction. Therefore, during the assembling of the battery units according to the present disclosure, the conventional end plate and side plate are replaced by the first holding portion and the second holding portion. Compared with the end plate and the side plate, the first holding portion and the second holding portion have the lighter weight and the smaller volume. In this way, the energy density of the battery module and the space utilization both can be improved, while facilitating the assembling of the battery units.

### BRIEF DESCRIPTION OF DRAWINGS

In order to more clearly illustrate the technical solutions of the embodiments of the present disclosure, the drawings used in the embodiments will be briefly described as below. The drawings described below are merely some embodiments of the present disclosure. Based on these drawings, those skilled in the art can obtain other drawings without paying creative efforts.

FIG. 1 is a structural schematic diagram of a battery module according to a first embodiment of the present disclosure;

FIG. 2 is an exploded view of FIG. 1;

FIG. 3 is a structural schematic diagram of a connecting component shown in FIG. 2 according to a specific embodiment;

FIG. 4 is a structural schematic diagram of an insulating component shown in FIG. 2;

FIG. 5 is a top view of a battery module according to a second embodiment of the present disclosure;

FIG. 6 is a partial enlarged view of a portion I shown in FIG. 5;

FIG. 7 is a top view of a battery module according to a third embodiment of the present disclosure;

FIG. 8 is a partial enlarged view of a portion II shown in FIG. 7;

FIG. 9 is a structural schematic diagram of battery modules of FIG. 1 connected along a length direction L;

FIG. 10 is a structural schematic diagram of battery modules of FIG. 5 connected along a width direction W;

FIG. 11 is a partial enlarged view of a portion III of FIG. 10;

FIG. 12 is a structural schematic diagram of battery modules of FIG. 7 connected along a length direction L and a width direction W; and

FIG. 13 is a partial enlarged view of a portion IV shown in FIG. 12.

Reference number:

1 battery module
11 battery unit array structure
   111 battery unit
   112 first end potion
   113 second end portion
   114 first side portion
   115 second side portion
12 connecting component
   121 first holding portion
   122 second holding portion
   123 first connecting plate
      123a first mounting hole
   124 second connecting plate
   125 second connecting portion
      125a third mounting hole
   126 first groove
   127 second groove
13 insulating component
   131 first insulating plate
   132 second insulating plate
   133 third insulating plate
   134 fourth insulating plate
14 first bundling belt
15 second bundling belt

### DETAILED DESCRIPTION

For better understanding the technical solutions of the present disclosure, the embodiments of the present disclosure will be described in detail below with reference to the accompanying drawings.

It should be understood that, the described embodiments are merely parts of, rather than all of the embodiments of the present disclosure. Based on these embodiments described in the present disclosure, other embodiments obtained by those skilled in the art without paying creative efforts shall fall within the protection scope of the present disclosure.

The terms in the embodiments of the present disclosure are merely used for describing specific embodiments, but not intended to limit the present disclosure. The singular forms such as “a”, “an”, “the said” and “the” are also intended to include the plural forms, unless the context indicates otherwise.

It should be understood that the term “and/or” used in the context of the present disclosure is to describe a correlation relation of related objects, indicating that there may be three relations, e.g., A and/or B may indicate only A, both A and B, and only B. In addition, the symbol “/” in the context generally indicates that the relation between the objects in front and at the back of “/” is an “or” relationship.

It should be understood that terms indicating orientations or positions, such as “upper”, “lower”, “left”, “right”, etc., generally are used to describe the orientations or positions with reference to the drawings, and thus should not be construed as a limitation of the present disclosure. It also should be understood that when an element is referred as being “on” or “under” another element, the element can be directly located “on” or “under” another element or connected to another element with an intermediate element.

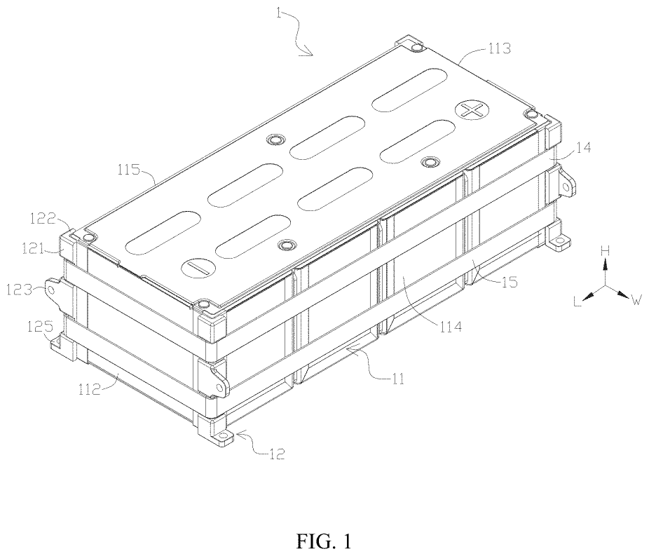

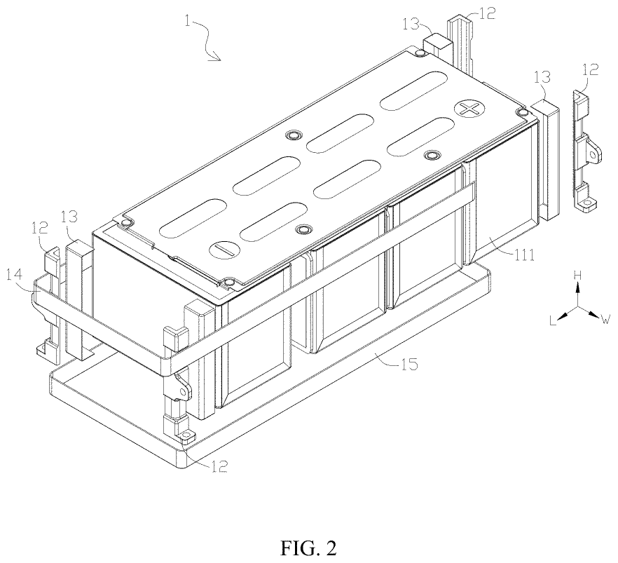

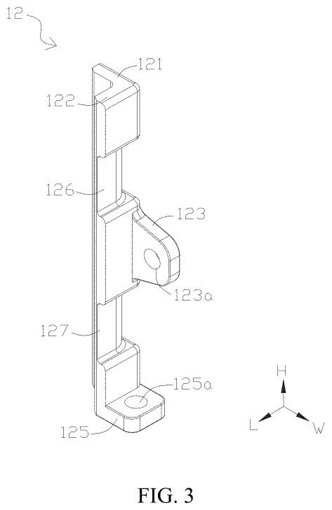

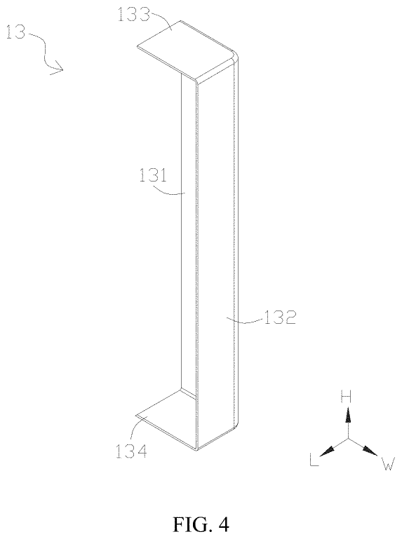

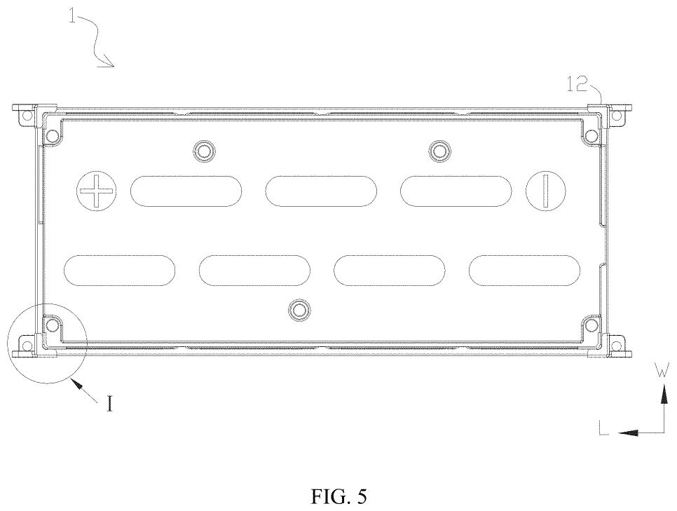

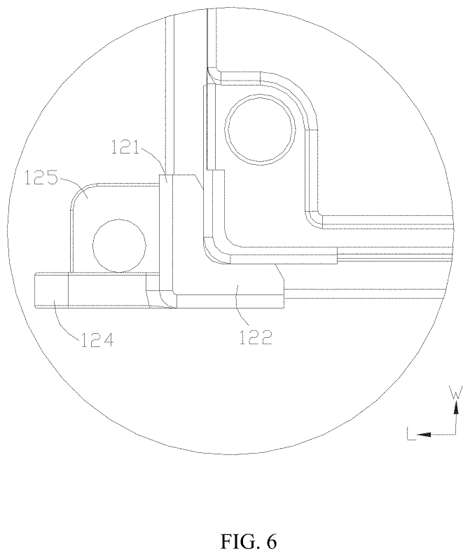

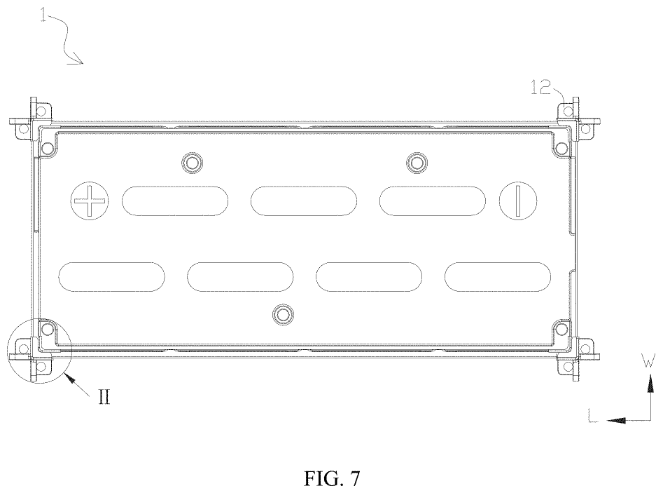

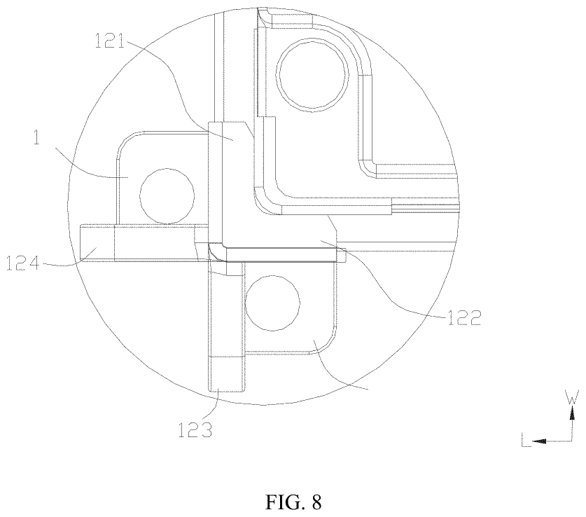

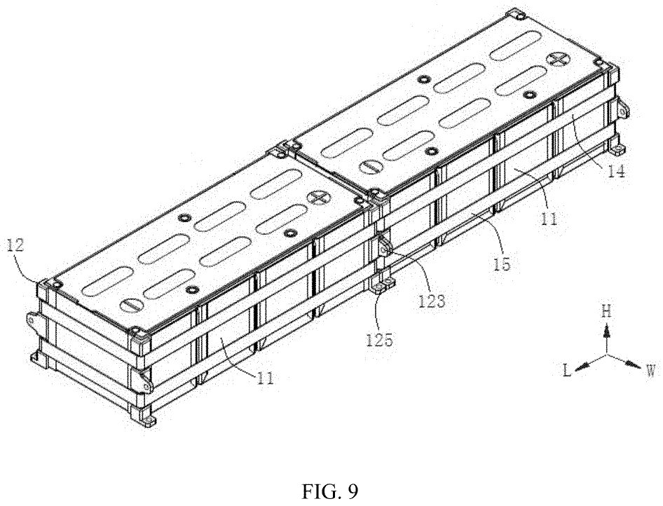

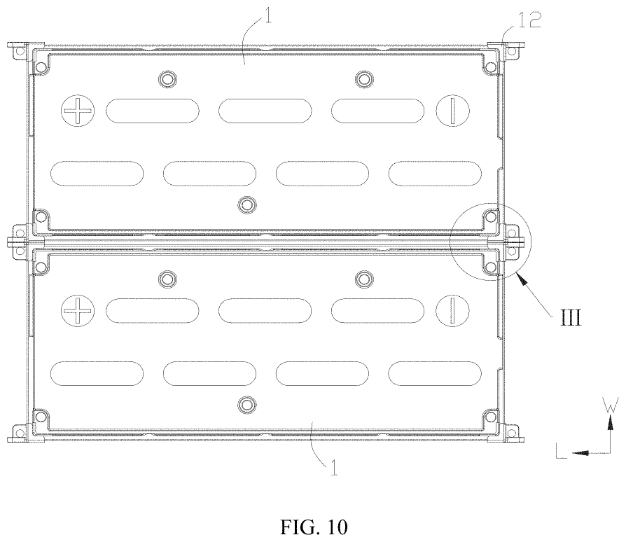

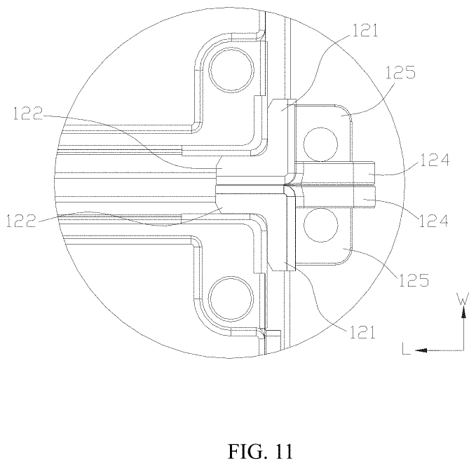

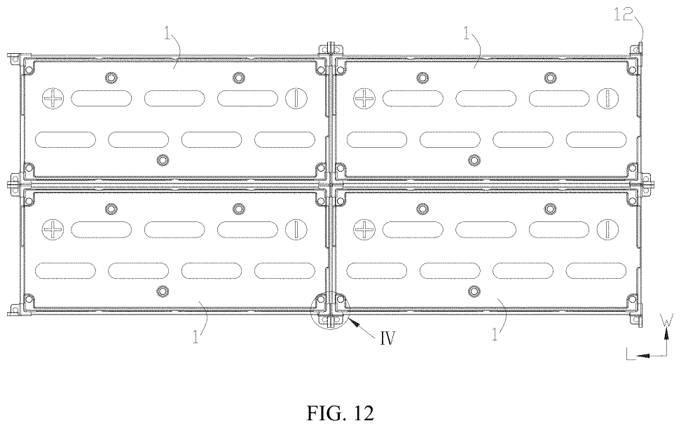

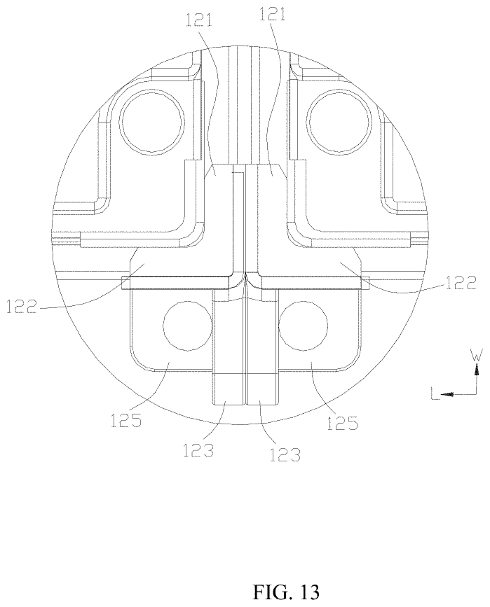

Referring to FIG. 1 to FIG. 13, FIG. 1 is a structural schematic diagram of a battery module according to a first embodiment of the present disclosure; FIG. 2 is an exploded view of FIG. 1; FIG. 3 is a structural schematic diagram of a connecting component shown in FIG. 2 according to a specific embodiment; FIG. 4 is a structural schematic diagram of an insulating component shown in FIG. 2; FIG. 5 is a top view of a battery module according to a second embodiment of the present disclosure; FIG. 6 is a partial enlarged view of a portion I shown in FIG. 5; FIG. 7 is a top view of a battery module according to a third embodiment of the present disclosure; FIG. 8 is a partial enlarged view of a portion II shown in FIG. 7; FIG. 9 is a structural schematic diagram of battery modules of FIG. 1 connected along a length direction L; FIG. 10 is a structural schematic diagram of battery modules of FIG. 5 connected along a width direction W; FIG. 11 is a partial enlarged view of a portion III of FIG. 10; FIG. 12 is a structural schematic diagram of battery modules of FIG. 7 connected along a length direction L and a width direction W; and FIG. 13 is a partial enlarged view of a portion IV shown in FIG. 12.

The present disclosure provides a battery pack, and the battery pack includes a case and a plurality of battery modules 1 disposed in the case. The plurality of battery modules 1 can be stacked along any of three directions, i.e., a length direction L, a width direction W and a height direction H. For example, the battery modules 1 shown in FIG. 9 are stacked along the length direction L, the battery modules 1 shown in FIG. 10 are stacked along the width direction W, and the battery modules 1 shown in FIG. 12 are stacked along both the length direction L and the width direction W. The battery modules 1 are mounted in the case of the battery pack, and the case separates the battery modules 1 from the external environment to exert waterproof and dustproof effects.

As shown in FIG. 1 and FIG. 2, the battery module 1 includes a battery unit array structure 11, and the battery unit array structure 11 includes a plurality of battery units 111 stacked along the length direction L (a direction, in which the battery units 111 are stacked is the length direction L of the battery unit array structure 11). Adjacent battery units 111 can be connected by an adhesive. Along the length direction L, the battery unit array structure 11 has two opposite end portions, which are a first end portion 112 and a second end portion 113, respectively. Each of the first end portion 114 and the second end portion 115 is formed by an end surface of one battery unit 111. Along the width direction W, the battery unit array structure 11 has two opposite side portions, which are a first side portion 114 and a second side portion 115, respectively. Each of the first side portion 114 and the second side portion 115 is formed by a side surface of one battery unit 111.

The battery module 1 further includes at least two connecting components 12 that are spaced apart from each other. Each connecting component 12 includes a first holding portion 121 and a second holding portion 122. In each connecting component 12, at least two first holding portions 121 are located at two end portions of the battery unit array structure 11 along the length direction L, and are connected to a part of the two end portions. That is, at least one first holding portion 121 corresponds to the first end portion 112, and is fixedly connected to a part of the first end portion 112; and at least one first holding portion 121 corresponds to the second end portion 113 and is fixedly connected to a part of the second end portion 113.

Meanwhile, in each connecting component 12, at least two second holding portions 122 are located on both sides of the battery unit array structure 11 along the width direction W, and are fixedly connected with a part of the two side portions. That is, at least one second holding portion 122 corresponds to the first side portion 114 and is fixedly connected to a part of the first side portion 114, and at least one second holding portion 122 corresponds to the second side portion 115 and is fixedly connected to a part of the second side portion 115.

In the present disclosure, along the length direction L, one end of the battery unit array structure 11 is fixedly connected with at least one first holding portion 121, and the other end of the battery unit array structure 11 is fixedly connected with at least one first holding portion 121; and along the width direction W, one side of the battery unit array structure 11 is fixedly connected with at least one second holding portion 122 and the other side of the battery unit array structure 11 is fixedly connected with at least one second holding portion 122, such that the battery units 111 are integrally connected in the length direction L and the width direction W. Therefore, during the assembling of the battery units 111 according to the present disclosure, the conventional end plate and side plate are replaced by the first holding portion 121 and the second holding portion 122. Compared with the end plate and the side plate, the first holding portion 121 and the second holding portion 122 have the lighter weight and the smaller volume. In this way, the energy density of the battery module 1 and the space utilization both can be improved, while facilitating the assembling of the battery units 111.

It should be understood that, in the present disclosure, “the first holding portions 121 being respectively connected to a part of the two end portions” includes that they are directly connected to each other, or they are indirectly connected via other component such as a first insulating plate 131 as described below. Similarly, in the present disclosure, “the second holding portions 122 being respectively connected to a part of the two side portions” includes that they are directly connected to each other, or they are indirectly connected to each other via other component such as a second insulating plate 132 as described below.

In the battery module 1 of the present disclosure, when the battery unit 111 thermally expands, the expansion force acts on the first holding portion 121 of the connecting component 12. Therefore, the connecting component 12 is required to have a relatively high strength and rigidity. The connecting component 12 can be generally made of metal or other material having high strength, for example, the connecting component 12 can be made of cast aluminum. Since the conventional end plate and the side plate are omitted in the battery module according to the present disclosure, the space between adjacent connecting components 12 can be used as an expansion space for the thermal expansion of the battery units 111, thereby preventing the battery module 1 from being damaged by the accumulating expansion force of the battery units 11.

As shown in FIG. 3, in the connecting component 12, the first holding portion 121 is a first holding plate having a plate-like structure, and the second holding portion 122 is a second holding plate having a plate-like structure, and the first holding plate and the second holding plate are perpendicular to each other. The two holding plates are not strictly perpendicular to each other in the mathematical meaning, as long as they can be respectively connected to the end portion and side portion of the battery unit array structure 11. When the connecting component 12 is fixedly connected to the battery unit array structure 11, a plate surface of the first holding plate is perpendicular to the length direction L, i.e., the first holding plate is parallel with the first end portion 112 and the second end portion 113 of the battery unit array structure 11, such that the battery unit array structure 11 can be fixedly held in the length direction L by the at least two first holding plates; and the second holding plate is parallel with the first side portion 114 and the second side portion 115 of the battery unit array structure 11, such that the battery unit array structure 11 can be fixedly held in the width direction W by the at least two second holding plates.

The first holding plate has a smaller area than the first end portion 112 and the second end portion 113 of the battery unit array structure 11, i.e., the area of the first holding plate is smaller than the area of the conventional end plate. The second holding plate has a smaller area than the first side portion 114 and the second side portion 115 of the battery unit array structure 11, i.e., the area of the second holding plate is smaller than the area of the conventional side plate.

In the present embodiment, when the first holding portion 121 and the second holding portion 122 both have plate-like structures, there are several advantages such as simple structure, easier molding, as well as smaller thickness and weight, thereby further improving the energy density of the battery module 1. At the same time, under the same volume, the holding portions having the plate-like structure has a larger area for contacting the battery unit array structure 11, thereby improving the connection reliability.

In the embodiment shown in FIG. 1 and FIG. 2, the battery module 1 includes four connecting components 12. Each two of the four connecting components 12, as a group, are located at one end of the battery unit array structure 11 in the length direction L (or the width direction W). Each connecting component 12 is located at one of four corners of the battery unit array structure 11, and the four connecting components 12 include four first holding portions 121 and four second holding portions 122. Thus, in the battery unit array structure 11, along the length direction L, the first end portion 112 are fixedly connected with two first holding portions 121 and the second end portion 113 are fixedly connected by two first holding portions 121; and along the width direction W, the first side portion 114 are fixedly connected with two second holding portions 122 and the second side portion 115 are fixedly connected with two second holding portions 122.

In the present embodiment, the battery units 11 are grouped in such manner that a high connection reliability can be achieved by using the fewest connecting components 12. It is also possible that the battery module 1 includes other numbers of the connecting components 12. The number of the connecting components 12 is not specifically limited in the present disclosure, as long as the battery units 111 can be connected.

Further, as shown in FIG. 1 and FIG. 2, the battery module 1 further includes one or more bundling belts surrounding the battery unit array structure 11 and the connecting components 12, such that the battery units 11 are also fixed by the bundling belt in addition to the connecting components 12, thereby improving the connection reliability of each battery unit 111.

When the battery module 1 includes a plurality of bundling belts, the plurality of bundling belts is distributed along the height direction H. In the embodiment shown in FIG. 1 and FIG. 2, the battery module 1 includes two bundling belts, i.e., a first bundling belt 14 and a second bundling belt 15. Both bundling belts surround the battery unit array structure 11 and the connecting components 12, and are distributed along the height direction H. As shown in FIG. 3, a first groove 126 and a second groove 127 are provided on an external side of the connecting component 12, and the first groove 126 and the second groove 127 are distributed along the height direction H. Along the height direction H, a part of the first bundling belt 14 is disposed in the first groove 126 and matches the first groove 126. Along the height direction H, a part of the second bundling belt 15 is disposed in the second groove 127 and matches the second groove 127. The first groove 126 and the second groove 127 both are provided on the first holding portion 121 and the second holding portion 122 of the connecting component 12.

In the present embodiment, the first bundling belt 14 and the second bundling belt 15 can improve the connection reliability of the battery units 11, and in the meantime, the matching between the bundling belt and groove can prevent the bundled belt from detaching. The first bundling belt 14 and/or the second bundling belt 15 are made of a material having high rigidity such as spring steel or the like.

In the above embodiments, the connecting components 12 are generally made of a metal material to improve the rigidity thereof. As shown in FIG. 1 and FIG. 2, the battery module 1 further includes at least two insulating components 13, and each insulating component 13 is located between the connecting component 12 and the battery unit array structure 11 to insulate the connecting component 12 from the battery unit array structure 11. Therefore, in the battery module 1, a number of the insulating components 13 is not smaller than the number of the connecting components 12.

As shown in FIG. 4, the insulating component 13 includes a first insulating plate 131 and a second insulating plate 132. The first insulating plate 131 has a plate surface perpendicular to the length direction L, i.e., the first insulating plate 131 is parallel with the first holding portion 121, the first end portion 112 and the second end portion 113. The first insulating plate 131 covers at least the first holding plate (the first holding portion 121). Similarly, the second insulating plate 132 has a plate surface perpendicular to the width direction W, i.e., the second insulating plate 132 is parallel with the second holding portion 122, the first side portion 114 and the second side portion 115. The second insulating plate 132 covers at least the second holding plate (the second holding portion 122).

In this embodiment, the first holding portion 121 of the connecting component 12 and the battery unit array structure 11 are insulated by the first insulating plate 131, and the second holding portion 122 of the connecting component 12 and the battery unit array structure 11 are insulated by the second insulating plate 132.

Further, as shown in FIG. 4, the insulating component 13 includes a third insulating plate 133 and a fourth insulating plate 134. Each of the third insulating plate 133 and the fourth insulating plate 134 has a plate surface perpendicular to the height direction H. The third insulating plate 133 is connected to the top of the first insulating plate 131 and the top of the second insulating plate 132, and the fourth insulating plate 134 is connected to the bottom of the first insulating plate 131 and the bottom of the second insulating plate 132. The third insulating plate 133 abuts against the top of the battery unit array structure 11, and the fourth insulating plate 134 abuts against the bottom of the battery unit array structure 11.

Therefore, the insulating component 13 can achieve a complete insulation between the battery unit array structure 11 and the connecting component 12 along the length direction L, the width direction W, and the height direction H. The four insulating plates of the insulating component 13 are in contact with the surfaces of the battery unit array structure 11, such that the insulating component 13 can be mounted on the battery unit array structure 11. The first holding portion 121 and the second holding portion 122 of the connecting component 12 respectively abut against the first insulating plate 131 and the second insulating plate 132 of the insulating component 13, so as to form the connection between the insulating component 13 and the connecting component 12.

It is also possible that other connecting structures can be provided between the insulating component 13 and the battery unit array structure 11, between the insulating component 13 and the connecting component 12, so as to achieve connections therebetween. The connecting structures therebetween also can be omitted, which has advantages of simple structure, easier manufacturing, and increased energy density of the battery module 1.

Further, in the above embodiments, the connecting component 12 further includes a first connecting portion, and the first connecting portion is configured to be connected to an adjacent battery module 1. For example, two adjacent battery modules 1 both have a connecting component 12 provided with a first connecting portion, so that the two battery modules 1 can be fixedly connected through respective first connecting portions.

In this embodiment, the battery modules 1 of the battery pack are connected by respective connecting components 12. That is, the connecting components 12 can not only connect the plurality of battery units 111 to form the battery module 1, but also can connect adjacent battery modules 1. Therefore, compared with the battery pack known in the related art, the grouping manner according to the present disclosure has an advantage of simple structure and the connecting component 12 occupies a smaller space and has a lighter weight, thereby enhancing the space utilization of the battery case and improving the energy density and grouping efficiency of the battery pack.

For example, the first connecting portion of the connecting component 12 includes a first connecting plate 123 and/or a second connecting plate 124. The first connecting plate 123 has a plate surface perpendicular to the length direction L. Along the length direction L, the first connecting plates 123 of two adjacent battery modules 1 are fixedly connected, so that the two battery modules 1 are connected along the length direction L, as shown in FIG. 9. The second connecting plate 124 has a plate surface perpendicular to the width direction W. Along the width direction W, the second connecting plates 124 of two adjacent battery modules 1 are fixedly connected, so that the two battery modules 1 are connected along the width direction W, as shown in FIG. 10 and FIG. 11. As shown in FIG .12 and FIG. 13, the connecting component 12 includes the above first connecting plate 123 and second connecting plate 124, the first connecting plates 123 of two adjacent battery modules 1 are fixedly connected along the length direction L, and the second connecting plates 124 of two adjacent battery modules 1 are fixedly connected along the width direction W, so as to achieve the connections of the battery modules 1 along the length direction L and along the width direction W.

In this embodiment, the first connecting plate 123 is provided with a first mounting hole 123a, and the second connecting plate 124 is provided with a second mounting hole (not shown). The first mounting holes 123a of two adjacent battery modules 1 are communicated with one another, and the two adjacent battery modules 1 are fixedly connected via the two first mounting holes 123a. Additionally or alternatively, the second mounting holes of the two adjacent battery modules 1 are communicated with one another, and the two adjacent battery modules 1 are fixedly connected via the two second mounting holes.

In this embodiment, the first connecting plate 123 and/or the second connecting plate 124 have a flat plate structure, and thus have a smaller size in the height direction H, thereby reducing the weight and volume of the connecting component 12, and improving the energy density and space utilization of the battery pack.

Further, as shown in FIG. 3, the connecting component 12 further includes a second connecting portion 125. The second connecting portion 125 is fixed to the bottom of the first holding portion 121 and the bottom of the second holding portion 122, and/or the second connecting portion 125 is fixed to the top of the first holding portion 121 and the top of the second holding portion 122.

The second connecting portion 125 disposed at the bottom of the first holding portion 121 and the bottom of the second holding portion 122 is configured to be fixedly connected to the case of the battery pack. The second connecting portion 125 disposed at the top of the first holding portion 121 and the top of the second holding portion 122 is configured to be fixedly connected to the upper cover of the battery pack and is also configured to be connected to a beam of the case of the battery pack. In addition, when a plurality of battery modules 12 are stacked along the height direction H in the battery pack, the second connecting portion 125 located at the top of the first holding portion 121 and the top of the second holding portion 122 can also be used to be connected to an upper battery module 12, and specifically, connected to the second connecting portion 125 of the upper battery module 12 located at the bottom of the first holding portion 121 and the second holding portion 122.

In an embodiment, the second connecting portion 125 is provided with a third mounting hole 125a, and is fixedly connected to the above components via the third mounting hole 125a.

Therefore, in the present disclosure, the connecting component 12 has the following three functions of: connecting the battery unit array structures 11, connecting the adjacent battery modules 12, connecting the battery modules 12 with the case of the battery pack; and it also has the advantages of simple structure, small volume and small weight, thereby improving the energy density and the grouping efficiency of the battery pack. The above embodiments of the present disclosure are merely preferable embodiments, but not intended to limit the scope of the present disclosure. Any changes, equivalent substitutions or improvements made upon the concept of the present disclosure should fall into the protection scope of the present disclosure.

What is claimed is:

1. A battery module, comprising:
a battery unit array structure comprising a plurality of battery units stacked along a length direction L, wherein the battery unit array structure comprises two opposite end portions along the length direction L and two opposite side portions along a width direction W; and
at least two connecting components spaced apart from each other, each of the at least two connecting components comprising a first holding portion and a second holding portion,
wherein in each of the at least two connecting components, the first holding portion is located at one of the two end portions of the battery unit array structure along the length direction L, and connected to a part of the one of the two end portions, and
in each of the at least two connecting components, the second holding portion is located at one of the two side portions of the battery unit array structure along the width direction W, and connected to a part of the one of the two side portions.

2. The battery module according to claim 1, wherein each of the at least two connecting components comprises a first holding plate and a second holding plate perpendicular to the first holding plate,
the first holding plate is the first holding portion, and the second holding plate is the second holding portion, and
the first holding plate comprises a smaller area than the end portions, and the second holding plate comprises a smaller area than the side portions.

3. The battery module according to claim 2, further comprising at least one bundling belt surrounding the battery unit array structure and the at least two connecting components,
wherein each of the at least two connecting components is provided with a groove, and along a height direction H, a part of the at least one bundling belt is disposed in the groove.

4. The battery module according to claim 2, further comprising at least two insulating components, wherein each of the at least two insulating components is disposed between one of the at least two connecting components and the battery unit array structure.

5. The battery module according to claim 4, wherein each of the at least two insulating components comprises a first insulating plate and a second insulating plate,
the first insulating plate covers at least the first holding plate, and the second insulating plate covers at least the second holding plate.

6. The battery module according to claim 5, wherein each of the at least two insulating components further comprises a third insulating plate and a fourth insulating plate,
the third insulating plate is connected to a top of the first insulating plate and a top of the second insulating plate, and the third insulating plate abuts against a top of the battery unit array structure, and
the fourth insulating plate is connected to a bottom of the first insulating plate and a bottom of the second insulating plate, and the fourth insulating plate abuts against a bottom of the battery unit array structure.

7. The battery module according to claim 1, wherein each of the least two connecting components further comprises a first connecting portion, and the first connecting portion is configured to be connected to an adjacent battery module.

8. A battery pack, comprising:
a case having an inner cavity; and
a plurality of battery modules disposed in the inner cavity,
wherein each of the plurality of battery modules is the battery module according to claim 1.

9. The battery pack according to claim 8, wherein each of the least two connecting components comprises a first connecting portion, and the first connecting portion comprises a first connecting plate and/or a second connecting plate,
along the length direction L, two adjacent battery modules of the plurality of battery modules are fixedly connected by the first connecting plate, and/ or
along the width direction W, two adjacent battery modules of the plurality of battery modules are fixedly connected by the second connecting plate.

10. The battery pack according to claim 8, wherein each of the least two connecting components comprises a second connecting portion,
wherein the second connecting portion is fixed to a bottom of the first holding portion and a bottom of the second holding portion, and/or
the second connecting portion is fixed to a top of the first holding portion and a top of the second holding portion.
